(19) United States
(12) Patent Application Publication
(10) Pub. No.: US 2007/0150610 A1
(43) Pub. Date: Jun. 28, 2007

(54) Javascript relay

(76) Inventors: Konstantin Vassilev, Rancho Santa Margarita, CA (US); Sylvester Ziolkowski, Rancho Santa Margarita, CA (US); Michael Lee, Silverado, CA (US)

Correspondence Address: FISH & ASSOCIATES, PC;ROBERT D. FISH, 2603 Main Street, Suite 1050, Irvine, CA, 92614-6232, US

(21) Appl. No.: 11/318,376

(22) Filed: Dec. 22, 2005

(51) Int. Cl. G06F 15/16

(52) U.S. Cl. 709/230

(57) ABSTRACT

A platform-independent, SOAP toolkit-independent, server environment providing web services in which a web browser can make an application-to-application web services request over HTTP by having one or more proxy servers installed on an application server to receive such web services requests from a browser. The proxy server adds customer credential elements to the web services requests and converts the web services request in SOAP format before the request is forwarded to a web services server for customer subscription authentication and further processing.

### FIELD OF THE INVENTION

The field of the invention is related to data quality verification, more specifically, making a web services call directly from a browser for application-to-application communication.

### BACKGROUND

Web services allows two applications to seamlessly communicate over the Internet, without any platform and programming language differences. This means that, for instance, a Perl script running on a Linux machine can easily call NET code running on Windows 2000™, over the Internet. This is made possible via two very successful standards, XML and HTTP. The term “calling a web service” refers to actions that a client application performs to use the web service. Over HTTP, one application sends XML request package to the other application, mostly over the Internet, and receives an XML response package as the result of the Web method.

One of the primary pillars for Web services is SOAP, a W3C specification, which defines the use of XML and Web protocols (such as HTTP) for XML messaging. SOAP stands for Simple Object Access Protocol, an XML-based object invocation protocol. SOAP was originally developed for distributed applications to communicate over HTTP and through corporate firewalls. SOAP defines the use of XML and HTTP to access services, objects and servers in a platform-independent manner.

SOAP does not itself define any application semantics such as a programming model or implementation specific semantics; rather it defines a simple mechanism for expressing application semantics by providing a modular packaging model and encoding mechanisms for encoding data within modules. This allows SOAP to be used in a large variety of systems ranging from messaging systems to remote procedure calls (RPC). SOAP consists of three parts:

First, the SOAP envelope construct defines an overall framework for expressing what is in a message; who should deal with it, and whether it is optional or mandatory.

Second, the SOAP encoding rules defines a serialization mechanism that can be used to exchange instances of application-defined data types.

Third, the SOAP RPC representation defines a convention that can be used to represent remote procedure calls and responses.

In addition to the above, SOAP also defines two protocol bindings that describe how a SOAP message can be carried in HTTP. Using Web services can be loosely termed as sending SOAP requests and receiving back SOAP responses.

The use of SOAP in web services, however, requires the use of SOAP toolkits. Currently, there are many SOAP toolkits available that attempt to simplify this process of sending and receiving SOAP messages, as well as working with the resultant XML.

Examples of SOAP toolkits include Apache™ Axis™, Java-based Apache™ SOAP toolkit that can be used to run a web services on servers, Java™ Web Services Developer Pack manufactured by Sun Microsystems Inc. located in Santa Clara, Calif., IBM™ WebSphere™ Application Server manufactured by IBM™, located in Armonk, N.Y., Microsoft™ SOAP Toolkit 3.0 and Microsoft™.Net Framework both manufactured by Microsoft located in Redmond, Wash.

There remains a need, however, to further simplify the process of making a web services call while providing secured subscriber verification process for validating SOAP transactions/requests.

This and all other referenced patents and applications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

The present invention provides apparatus, systems and methods in which a web browser can make an application-to-application web services request over HTTP by having one or more proxy servers (which could be nothing more than relay pages) installed on a client's application server) to receive such requests from a browser. Optionally, the proxy server adds customer credential elements to the web services requests and forwards the web services requests in SOAP format to a web services server for authentication and further processing of the request.

Among the many different possibilities contemplated, the method of calling web services directly from a browser further comprises at least one proxy server installed on the application server to process a plurality of requests from different browsers of different platforms. It is further contemplated that the method of sending web services requests includes sending web services requests from the browser in a POST or GET format over HTTP. Still further, it is preferred that the browser sends the web services request by using XMLHTTP via a web browser scripting language.

In other preferred embodiments, the web services system further includes a web browser where its scripting language is Java Script. Further, contemplated web services request is sent from a browser platform selected from a group consisting of Internet Explorer, Opera, Netscape, Mozilla, Lynx, and WebTV.

Further, it is contemplated that the proxy server converts web services requests to SOAP format and forwards requests to web services server via HTTP using XMLHTTP object installed on the application server. It is still further contemplated that there are a number of proxy servers each written in a different programming language from the other. These languages include ASP, ASPX, NET, PHP, Java, and the like.

In preferred embodiments, the web services server processes the request and the resulting response such that a response is sent back to the proxy server, and then to the browser, in XML format.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

FIG. 1 is a diagram illustrating a contemplated web services environment.

FIG. 2 is a flow diagram illustrating an embodiment of the web services method.

FIG. 3 is another flow diagram illustrating an embodiment of the web services method.

### DETAILED DESCRIPTION

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that the spirit of the invention also intends to encompass.

The inventors have discovered that proxy servers installed on an application server can advantageously solve customer credential issues in a web services environment, and can advantageously increase efficiency in sending web services requests by a browser in a web services environment. By having a plurality of proxy servers, a number of browser types can be accommodated without resorting to the use of SOAP toolkits in converting web services requests to SOAP format. Each of the proxy servers can advantageously add customer credential element/data to the web services requests, as oppose to having the browsers to add such customer credential element/data to the requests.

As used herein, the phrase “making a web services call,” also synonymous with “making a web services request,” refers to actions that a client application performs to use the web service. For example, a user invokes a web service call at a browser to communicate with another application over the internet. Web services allows two applications to communicate over the Internet, without any platform and programming language differences. This means that, for instance, a Perl™ script running on a Linux machine can easily call NET code running on Windows 2000™, over the Internet.

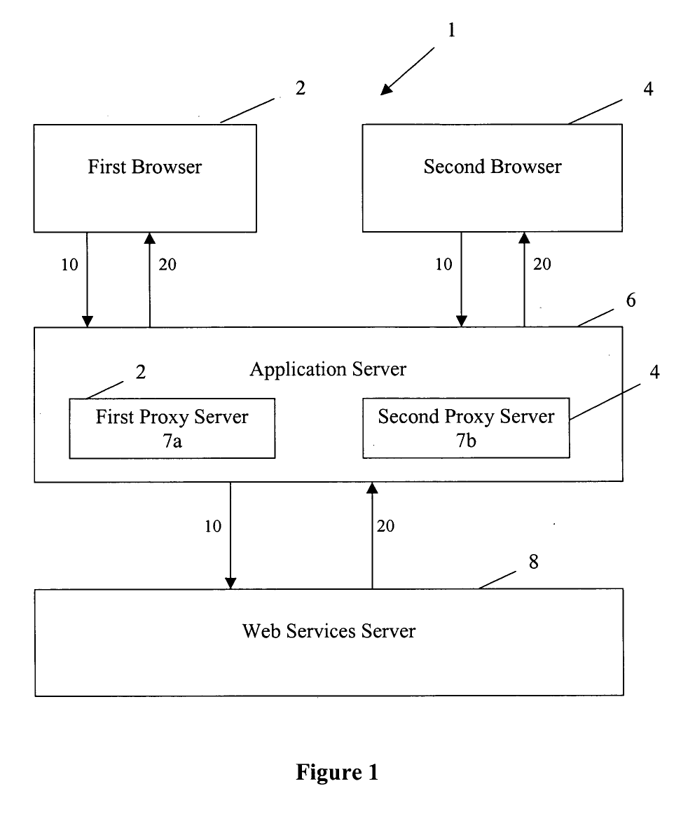

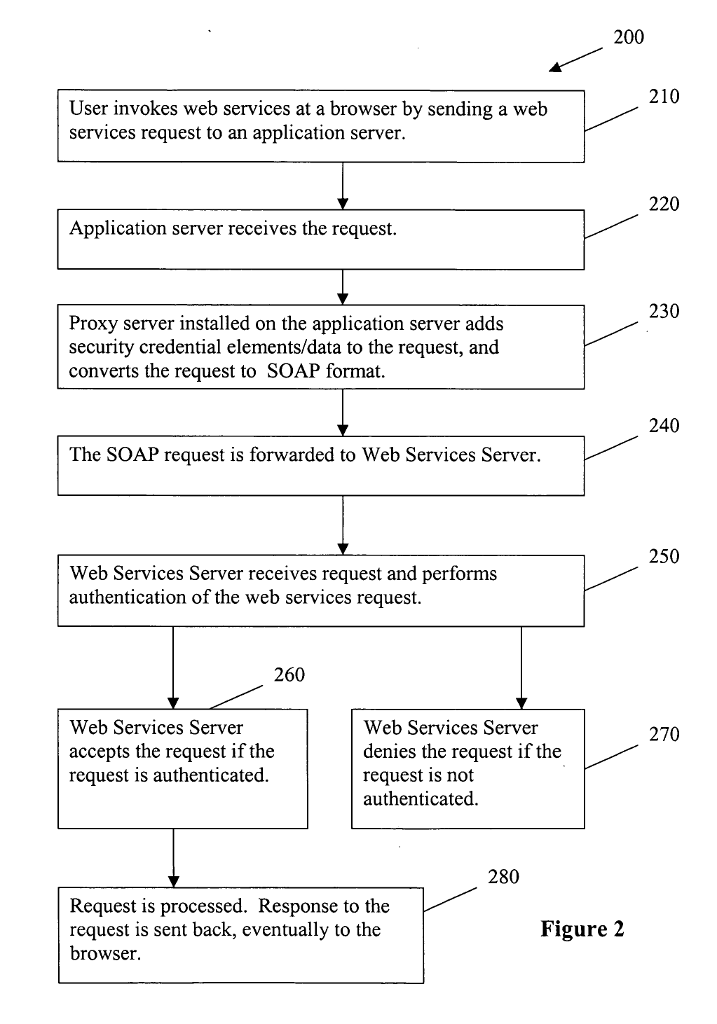

FIGS. 1 and 2 illustrate preferred aspects of the inventive subject matter. In FIG. 1, a server computing environment 1 providing web services for sending application-to-application web services request from a web browser includes a first browser 2 for making a first web services request 10 over HTTP. In one preferred aspect, the first browser 2 can have a browser-side Java Script™ library capable of sending a first web services request to a first proxy server 7a.

The first browser 2 preferably sends a web services request 10 in a POST format. Alternatively, it can be sent in a GET format.

POST and GET are two possible methods identifying requests sent in the request-response protocol called HTTP. The Hypertext Transfer Protocol (HTTP) is the most ubiquitous of the Internet protocols. Other than its ability to fetch pages of Hypertext Markup Language (HTML) content for display in a web browser, HTTP also acts as a general-purpose transport for any type of data.

A GET request fetches data from a web server based solely on a URL value and a set of HTTP headers. In contrast, a POST request sends additional data to the web server, specified after the URL, the headers, and a blank line to indicate the end of the headers.

In one preferred embodiment, the first browser sends the first web services request by using XMLHTTP via a web browser scripting language such as Java Script.

The web services request 10 is then received by application server 6. Application server 6 has a first proxy server 7a installed. The first proxy server 7a is tailored to process requests sent from specific browser types. Additionally, first proxy server 7a stores customer credential elements/data. In this example, proxy server 7a receives first web services request 10 and adds customer credential elements/data to the first web service request 10. The customer credential elements/data provides information about the customer, such as subscription status, account receivable status. The first proxy server 7A also converts, or translates, the request 10 into SOAP format, and then forwards the customer credential element embedded first web services request 10 to a web services server 8 for further processing.

Still further contemplated embodiments of the inventive subject matter include having a second proxy server 7b installed on the application server 6 to process a second request 10 from a second browser 4. As described above for first proxy server 7a, second proxy server 7b is adapted to process web services requests send from specific browser platforms. Here, proxy server 7b is adapted to accommodate requests sent from second browser 4, which has a platform different from that of the first browser 2. Second proxy server 7b can convert request from second browser into SOAP format and stores customer credential element/data. Further, second proxy server 7b can add customer credential element/data to the request for authentication purposes. Additionally, it should be appreciated that contemplated application server 6 can have additional proxy servers to accommodate web services requests sent from many other contemplated browser platforms.

Contemplated browser platforms, for which the disclosed proxy servers can accommodate, can be any available browser platform types, such platforms include Internet Explorer™, Opera™, Netscape™, Mozilla™, LynX™, and WebTV™.

In one contemplated embodiment, the first proxy server 7a is written in a different programming language than the second proxy server 7b. The first and second proxy server 7a, 7b can be written in at least one language selected from the group consisting of ASP, ASPX, NET, PBP, and Java.

In some preferred embodiments, the first and second web services requests 10 in SOAP format are sent to the web services server via HTTP, optionally using XMLHTTP object installed on the application server, and optionally in POST or GET format.

Further contemplated is a web services server 8 that receives first web services request 10 from first proxy server 7a in SOAP format, as POST or GET over HTTP. The web services server initiates an authenticating process by first identifying the customer credential elements embedded in the first web services request 10. As those of ordinary skill in the art will recognize, there are various ways of identifying and authenticating customer credential elements, such as comparing the customer credential elements against a list of approved customer credential elements/data to determine if the request was sent by someone having permission to the requested web service.

One example where such authentication process is critical is when application server 6 and web services server 8 are in a subscriber to service-provider relationship. In such instance, the service-provider (the web services server 8) would prefer to process web services requests sent by subscribers (application server 6) who are up to date in their subscription payments for subscribing to the web service. Therefore, the authentication process allows the web services provider to deny web services request sent by delinquent subscribers.

After proper authentication process and approval of the request 10, the web services server 8 processes the web services request 10 for application-to-application communication.

In one contemplated embodiment, the web services server 8 sends a response 20 back to the application server 6 in XML format. The application server 6 and its corresponding proxy server then send the response 20 back to the corresponding browser in XML format.

In FIG. 2, a preferred method 200 comprises the following steps:
Step 210, user invokes web services at a browser by sending a web services request to an application server;
Step 220, application server receives the request;
Step 230, proxy server installed on the application server adds security credential elements/data to the request, and converts the request to SOAP format;
Step 240, the SOAP request is forwarded to Web Services Server;
Step 250, the Web Services Server receives request and performs authentication of the web services request;
Step 260, the Web Services Server accepts the request if the request is authenticated;
Step 270, the Web Services Server denies the request if the request is not authenticated; and
Step 280, the request is processed. Response to the request is sent back, eventually to the browser.

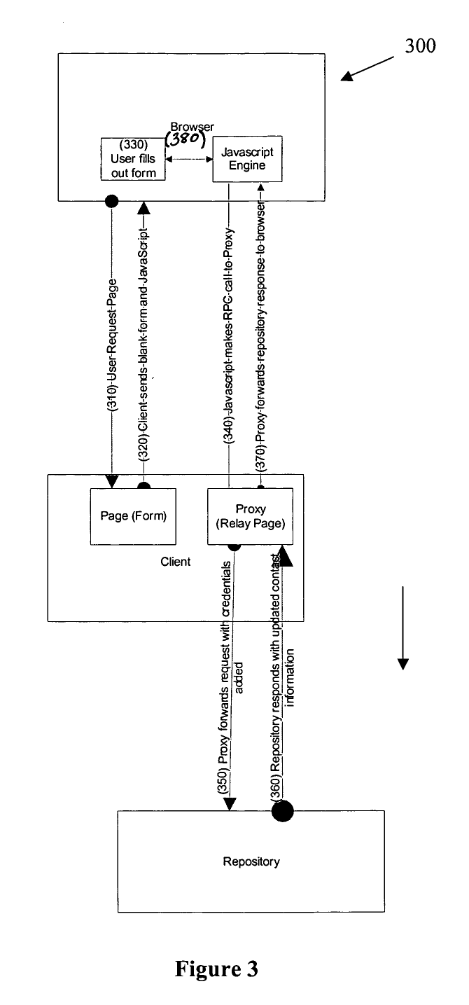

In FIG. 3, a preferred method 300 comprises the following steps:
Step 310, user requests a page from the client that contains location for blank contact information to be entered;
Step 320, client responds with blank form (page) and some JavaScript or VBScript that will get executed by the browser;
Step 330, user enters contact information into the form/page and requests the verification of the data;
Step 340, JavaScript™ (or VBScript) interpreter makes an RPC call to the proxy on the client's web server;
Step 350, proxy adds credentials to the supplied contact information and forwards the request to the repository with and RPC call (which may or may not be different than the RPC protocol in call 4;
Step 360, repository checks the credentials and contact information and responds with updated contact information and/or possibly appropriate error messages;
Step 370, proxy intercepts the response from the repository and forwards it to the browser, possibly reformatting it for different RPC protocols; and
Step 380, the browser displays the updated contact information to the user.

### EXAMPLE 1

A credit card issuing company runs a website to which consumers can visit and apply for a credit card by filling out an on-line application form. The application approval process involves verification of the physical addresses entered by consumers. Verification process can be quite time-consuming and labor intensive, since incorrectly entered addresses results in voluminous returned mails requiring follow-up by the credit card issuing company. The credit card issuing company can make the verification process more efficient by subscribing to a data quality solutions provider.

The data quality solutions provider provides real-time address and telephone number validation via the Internet by first installing proxy servers in the credit card issuing company's application server. Information entered by the consumer at a browser is wrapped into a web services request and sent to the credit card issuing company's application server. The proxy server then translates the web services requests into SOAP format at run time (as opposed to at design time by existing SOAP toolkits), and adds credential elements to the web service request. The credential elements include information regarding the credit card issuing company subscription status and account receivable status. The request is then sent to a web services server at the data quality solutions provider for verification/authentication. The web services server checks the customer credential data and processes only request sent from customers who has paid for the subscription. Once the web services server verifies the customer credential data, the web services server then processes the request and verifies the physical address. Subsequently, the web services server sends the response back to the application server, which then sends the response back to the browser. If the physical address is validated, the consumer can continue to fill out the credit card application at the browser. If not validated, the consumer is asked to enter a correct physical address.

This web services environment is platform neutral, allowing customers who use open source technology, including the Apache Web server running on Linux and the PostgreSQL and MySQL open source databases, to access web services.

Thus, specific embodiments and applications of Javascript Relay™ have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for making an application-to-application web services request from a web browser, the method comprising:
a first browser making a first web services request over HTTP;
a first proxy server receiving the first web services request, and adding customer credential elements to the first web services request for validating a customer's subscription status;
wherein the first proxy server is installed on an application server;
the first proxy server converts the first web services request into SOAP format at run time and sends the request to a web services server; and
a web services server authenticating the request by identifying the customer credential elements to determine if the request was sent by a customer that has permission to the requested web service.

2. The method of claim 1 further comprising the step of using a second proxy server installed on the application server to process a second request from a second browser, wherein the second browser has a different browser platform from the first browser.

3. The method of claim 1, wherein the first web services request from the first browser is in a POST or GET format.

4. The method of claim 3, wherein the first proxy server converts the first web services request to SOAP format and forwards the first web services request to the web services server via HTTP using XMLHTTP object installed on the application server.

5. The method of claim 2, wherein the first proxy server is written in a different programming language than the second proxy server.

6. The method of claim 5, wherein the first and second proxy servers are each written in one language selected from the group consisting of ASP, ASPX, NET, PHP, and Java.

7. The method of claim 1 wherein the first proxy server is capable of converting the first web services request to SOAP format, and wherein the first web services request is sent from a browser platform selected from a group consisting of Internet Explorer, Opera, Netscape, Mozilla, Lynx, and WebTV.

8. The method of claim 1, wherein a response is sent back to the first browser from the first proxy server in XML format.

9. The method of claim 1, wherein the first browser sends the first web services request by using XMLHTTP via a web browser scripting language.

10. The method of claim 9, wherein the web browser scripting language is Java Script.

11. A server computing environment providing web services comprising:
a first browser having a browser-side Java Script library capable of sending a first web services request to a first proxy server;
wherein the first proxy server is capable of translating the first web services request into SOAP format;
wherein the first proxy server adds customer credential data to the first web services request;
a web services server to communicate web services and associated web services by receiving the first web services request and perform a customer credential data authentication to verify subscription status; and
wherein the web services server sends back a response as XML to the first proxy server.

12. The environment of claim 11 further comprising a second proxy server installed on a application server capable of converting a second web services request to SOAP format, wherein the second web services request is sent from a second browser, and wherein the second browser has a different browser platform from the first browser.

13. The environment of claim 12 wherein the second proxy server stores customer credential data and is capable of adding customer credential data to the second web services request for authentication by the web services server.

14. The environment of claim 13, wherein the second request is transported via HTTP to the web services server for authentication.

15. The environment of claim 11, wherein the first browser sends a request to a first proxy server in POST or GET over HTTP.

16. The environment of claim 11, wherein the first proxy server sends the response back to the first browser as XML.

17. The environment of claim 11, wherein the web services server checks the customer credential data and only gives web services access to customers whose subscriptions to web services are paid.
